(19) United States
(12) Patent Application Publication
(10) Pub. No.: US 2025/0272904 A1
(43) Pub. Date: Aug. 28, 2025

(54) VIRTUAL HUMAN-BASED INTERACTION METHODS, SYSTEMS, AND DEVICES

(71) Applicant: HITHINK ROYALFLUSH INFORMATION NETWORK CO., LTD., Hangzhou (CN)

(72) Inventor: Zheng YI, Hangzhou (CN)

(73) Assignee: HITHINK ROYALFLUSH INFORMATION NETWORK CO., LTD., Hangzhou (CN)

(21) Appl. No.: 18/777,522

(22) Filed: Jul. 18, 2024

(30) Foreign Application Priority Data
Feb. 22, 2024 (CN) 202410199561.2

(51) Int. Cl. G06T 13/40; G06T 7/70; G06V 40/16

(52) U.S. Cl. CPC G06T 13/40; G06T 7/70; G06V 40/168; G06V 40/174; G06T 2207/30244

(57) ABSTRACT

Embodiments of the present disclosure provide virtual human-based interaction methods, systems, and devices. The methods include obtaining input data. The input data comprises at least one of description data or deduction data of a character. The methods include obtaining feature data of the character based on the input data. The feature data of the character at least comprises an expression feature of the character. The methods further include generating a virtual human based on the feature data of the character and dynamically displaying the virtual human on a display interface.

### CROSS-REFERENCE TO RELATED APPLICATIONS

This application claims the priority of Chinese patent application No. 202410199561.2, filed on Feb. 22, 2024, the contents of which are hereby incorporated by reference.

### TECHNICAL FIELD

The present disclosure relates to the field of artificial intelligence and terminal interaction technology, and in particular, to virtual human-based interaction methods, systems, and devices.

### BACKGROUND

With the development of terminal interaction technology, users have increasingly diverse and high demands for terminal interaction. Specifically, as users' demand for information understanding and intelligent interaction deepens, more personalized interactive experiences and more interactive needs in scenarios are needed, such as knowledge acquisition, customer service Q&A, idol interactive experience, commemoration of relatives and friends, etc.

Accordingly, it is desirable to provide an interaction method, system, and device that satisfies the need for more personalized interaction experiences and more scenarios of interaction.

### SUMMARY

One of the embodiments of the present disclosure provides a virtual human-based interaction method, comprising obtaining input data, wherein the input data includes at least one of description data or deduction data of a character; obtaining feature data of the character based on the input data, wherein the feature data at least includes an expression feature of the character; generating a virtual human based on the feature data; and dynamically displaying the virtual human on a display interface.

One of the embodiments of the present disclosure provides a virtual human-based interaction system, comprising an input data obtaining module configured to obtain input data, wherein the input data includes at least one of description data or deduction data of a character; a feature data obtaining module configured to obtain feature data of the character based on the input data, wherein the feature data at least includes an expression feature of the character; and a virtual human generating and displaying module configured to generate a virtual human based on the feature data and dynamically display the virtual human on a display interface.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary application scenario of a virtual human-based interaction system according to some embodiments of the present disclosure;

FIG. 2 is a block diagram illustrating an exemplary virtual human-based interaction system according to some embodiments of the present disclosure;

FIG. 3 is a flowchart illustrating an exemplary process of a virtual human-based interaction method according to some embodiments of the present disclosure;

FIG. 4 is a flowchart illustrating an exemplary process for driving a virtual human to engage in a dialogue and a user according to some embodiments of the present disclosure;

FIG. 5 is a flowchart illustrating an exemplary process for generating an image of a virtual human according to some embodiments of the present disclosure;

FIG. 6 is a flowchart illustrating an exemplary process for generating a facial expression of a virtual human according to some embodiments of the present disclosure;

FIG. 7 is a flowchart illustrating an exemplary process for generating an action of a virtual human according to some embodiments of the present disclosure; and

FIG. 8A and FIG. 8B are schematic diagrams illustrating exemplary display interfaces of virtual human-based interaction according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device” as used herein, “unit,” and/or “module” are used herein as a way to distinguish between different components, elements, parts, sections, or assemblies at different levels. However, the words may be replaced by other expressions if other words accomplish the same purpose.

As shown in the present disclosure and the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements that do not constitute an exclusive list, and the method or device may also include other steps or elements.

Flowcharts are used in the present disclosure to illustrate operations performed by a system in accordance with embodiments of the present disclosure. It should be appreciated that the preceding or following operations are not necessarily performed in an exact sequence. Instead, steps can be processed in reverse order or simultaneously. Also, it is possible to add other operations to these processes or remove a step or steps from them.

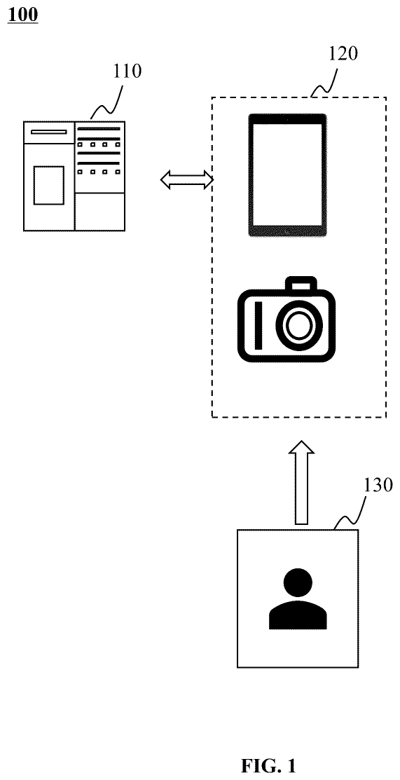

FIG. 1 is a schematic diagram illustrating an exemplary application scenario of a virtual human-based interaction system according to some embodiments of the present disclosure. In some embodiments, in an application scenario 100 of a virtual human-based interaction system, the terminal interaction based on a virtual human may be realized by implementing methods and/or processes disclosed in the present disclosure.

As shown in FIG. 1, the application scenario 100 of the virtual human-based interaction system involved in the embodiments of the present disclosure may include a processor 110, a user terminal 120, and input data 130.

The processor 110 may process information and/or data related to the application scenario 100 of the virtual human-based interaction system to perform one or more of the functions described in the present disclosure. For example, the processor 110 may obtain feature data of a character based on input data. As another example, the processor 110 may generate a virtual human based on the feature data of the character. In some embodiments, the processor 110 may include one or more processing engines (e.g., a single-chip processing engine or a multi-chip processing engine). Merely by way of example, the processor 110 may include a central processing unit (CPU), an application-specific integrated circuit (ASIC), an application-specific instruction processor (ASIP), a graphics processor (GPU), a physical processor (PPU), a digital signal processor (DSP), a field-programmable gate array (FPGA), a programmable logic circuit (PLD), a controller, a microcontroller unit, a reduced instruction set computer (RISC), a microprocessor, or the like, or any combination thereof.

The user terminal 120 may provide functional components related to user interaction and may implement a user interaction function (e.g., providing or displaying information and data to the user). Merely by way of example, the user terminal 120 may be one of a mobile device, a tablet computer, a laptop computer, a desktop computer, and other devices having input and/or output functions, or any combination thereof. Merely by way of example, the output function may include, but is not limited to, acoustic output such as a voice, display screen display, somatosensory transmission such as vibration, an electromagnetic wave signal such as a light, or the like, or a combination thereof. Merely by way of example, the input function may include, but is not limited to, keyboard input, touch screen input, voice input, motion event input such as tilting/shaking/rotating/swinging of the device (e.g., the user terminal 120 has a motion sensor to monitor various motion events described previously, thereby realizing the motion event input), electromagnetic wave signal input such as light (e.g., the user terminal 120 has a sensor that can detect an electromagnetic wave signal such as light, thereby realizing the electromagnetic wave signal input), or the like, or a combination thereof. In some embodiments, the user may input information and/or data via the user terminal 120, and the user may also obtain information and/or data (for example, the input data 130) via the user terminal 120. In some embodiments, the user terminal 120 may include a shooting device. The shooting device may be used to shoot to obtain an image, such as an image of an object in an environment. The shooting device may be various devices that can be used to shoot an image, and only by way of example, the shooting device may be a normal camera, a high-definition camera, a visible-light camera, an infrared camera, an optical-flow camera, a night vision camera, etc., or any combination thereof. The image shot by the shooting device may be a visible light image, an infrared image (an image made by acquiring the intensity of infrared light of an object), or the like.

The application scenario 100 of the virtual human-based interaction system may also include a storage device (or a memory, not shown in the figure), which may be used to store data and/or instructions. In some embodiments, the storage device may include a mass memory, a removable memory, a volatile read-write memory (e.g., a random-access memory RAM), a read-only memory (ROM), etc., or any combination thereof. In some embodiments, the storage device may be implemented on a cloud platform.

In some embodiments, the processor 110 may perform one or more of the functions described in the present disclosure by reading and executing data and/or instructions stored in the storage device.

In some embodiments, one or more components (e.g., the processor 110, the user terminal 120, the storage device, etc.) of the application scenario 100 of the virtual human-based interaction system may communicate with each other to exchange information and/or data, such as to communicate over a network to exchange information and/or data. Merely by way of example, the user terminal 120 may receive an instruction sent by the processor 110 to shoot an image, the processor 110 may obtain the image shot by the shooting device, the processor 110 may send information and/or data, such as an instruction, to the user terminal 120 to realize one or more of the terminal interaction functions described in the present disclosure, and processor 110 may receive and process the information and/or data sent by the user terminal 120.

In some embodiments, the user terminal 120 may include a processor 110. In some embodiments, the user terminal 120 may include a storage device.

It should be noted that the application scenario 100 of the virtual human-based interaction system is provided for illustrative purposes only and is not intended to limit the scope of the present disclosure. For a person of ordinary skill in the art, a variety of modifications or variations may be made in accordance with the description in the present disclosure. For example, the application scenario 100 of the virtual human-based interaction system may be implemented on other devices with similar or different functionality. However, these changes and modifications do not depart from the scope of the present disclosure.

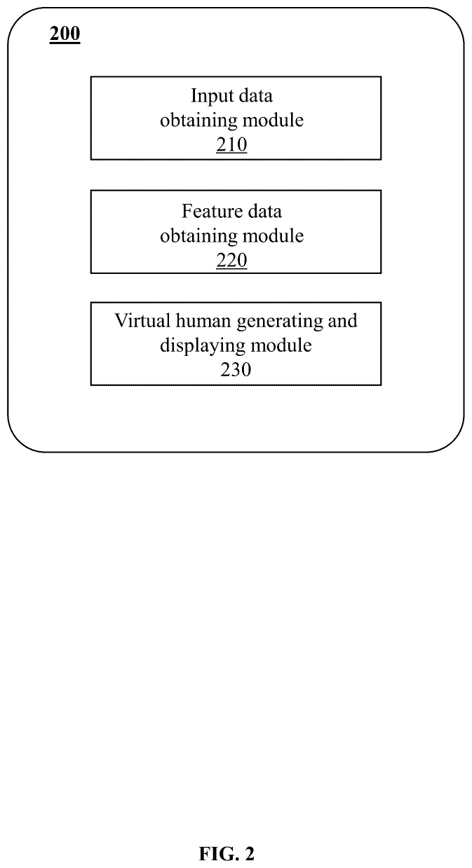

FIG. 2 is a block diagram illustrating an exemplary virtual human-based interaction system according to some embodiments of the present disclosure. In some embodiments, a virtual human-based interaction system 200 may be implemented on the processor 110.

As shown in FIG. 2, the virtual human-based interaction system 200 may include an input data obtaining module 210, a feature data obtaining module 220, and a virtual human generating and displaying module 230.

The input data obtaining module 210 may be used to obtain input data. In some embodiments, the input data may include at least one of description data and deduction data of a character. In some embodiments, the input data obtaining module 210 may perform one or more of the following operations including determining a corresponding target data source and a target mining strategy based on the description data of the character, and obtaining the deduction data of the character from the target data source based on the target mining strategy. In some embodiments, the target mining strategy may at least include an associated feature. In some embodiments, the deduction data may include an object image. In some embodiments, the input data obtaining module 210 may obtain the object image by shooting the object with a shooting device.

The feature data obtaining module 220 may be used to obtain feature data of the character based on the input data. In some embodiments, the feature data of the character may at least include an expression feature of the character. In some embodiments, the feature data obtaining module 220 may perform one or more of the following operations including filtering the deduction data to obtain a deduction feature; and based on the deduction feature, obtaining the feature data of the character. In some embodiments, the feature data of the character may include a portrait of the character. In some embodiments, the feature data obtaining module 220 may recognize the portrait of the character included in the object image. In some embodiments, the feature data of the character may also include a portrait feature of the character. In some embodiments, the feature data of the character may also include a facial expression feature and an action feature of the character.

The virtual human generating and displaying module 230 may be configured to generate a corresponding virtual human based on the feature data of the character, and dynamically display the virtual human on a display interface. In some embodiments, the virtual human generating and displaying module 230 may perform one or more of the following operations including obtaining a user discourse; determining a user discourse scenario based on the input data; generating a feedback discourse to the user based on the user discourse, the user discourse scenario, and the expression feature of the character, and displaying and/or voice broadcasting the feedback discourse through the virtual human. In some embodiments, the virtual human generating and displaying module 230 may perform one or more of the following operations including generating portrait information based on the portrait feature, and generating an image of the virtual human based on the portrait and/or the portrait information. In some embodiments, the portrait information may include at least one of a portrait type, a portrait facial feature, a portrait color feature, a portrait clothing feature, or a portrait size. In some embodiments, the virtual human generating and displaying module 230 may perform one or more of the following operations including determining a target facial expression generator; based on the expression feature and the facial expression feature, generating facial expression of the virtual human using the target facial expression generator, and displaying the facial expression by the virtual human; and/or determining a target action trajectory simulator; based on the expression feature and the facial expression feature, generating an action trajectory of the virtual human using the target action trajectory simulator, and executing the action trajectory by the virtual human. In some embodiments, the virtual human generating and displaying module 230 may appear the virtual human via a dynamic generation manner at a target position of the display interface. In some embodiments, the dynamic generation manner may include one or a combination of more of the following: the virtual human appears through a dynamic change in size, or the virtual human appears through a dynamic change in position. In some embodiments, the virtual human generating and displaying module 230 may perform one or more of the following operations including constructing an environmental map based on an environment image captured by the shooting device; determining a terminal position of a terminal device in the environmental map and a first position in the environmental map corresponding to a screen placement position of the virtual human in the display interface; and adjusting the first position based on a position change of the terminal position, so that the screen placement position of the virtual human in the display interface is adjusted based on the adjusted first position, wherein a first distance between the first position and the terminal position is maintained.

It should be appreciated that the system and its modules illustrated in FIG. 2 may be implemented utilizing a variety of means. For example, in some embodiments, the system and its modules may be implemented by hardware, software, or a combination of software and hardware.

It should be noted that the above description of the system and its modules is for descriptive convenience only, and does not limit the present disclosure to the scope of the cited embodiments. It is to be understood that for a person skilled in the art, after understanding the principle of the system, it may be possible to arbitrarily combine individual modules or form subsystems to be connected to other modules without departing from this principle. In some embodiments, the input data obtaining module 210, the feature data obtaining module 220, and the virtual human generating and displaying module 230 disclosed in FIG. 2 may be different modules in a system, and also may be a single module realizing the functions of two or more of the above modules. For example, the individual modules may share a common storage module, and the individual modules may each have a respective storage module. Morphisms such as these are within the scope of protection of the present disclosure.

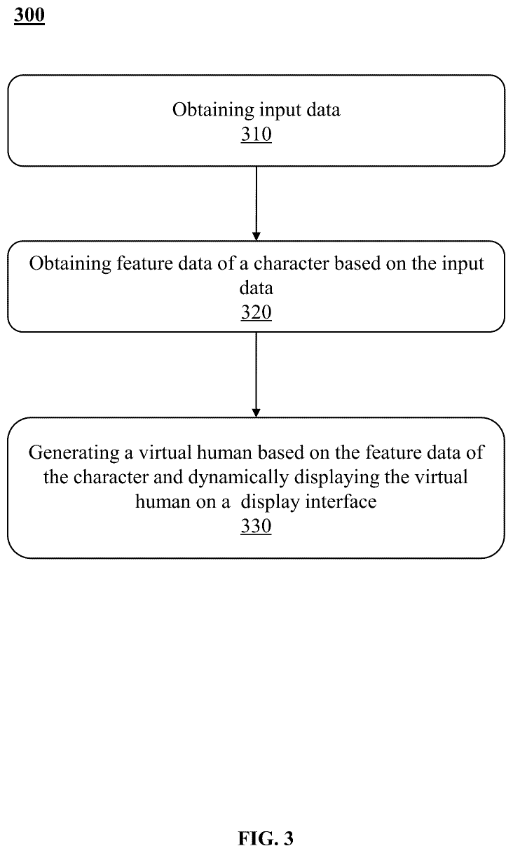

FIG. 3 is a flowchart illustrating an exemplary process of a virtual human-based interaction method according to some embodiments of the present disclosure. In some embodiments, a process 300 may be executed by the processor 110. In some embodiments, the process 300 may be implemented by the system 200 on the processor 110. The process 300 may include the following steps.

In step 310, input data is obtained. In some embodiments, step 310 may be performed by the input data obtaining module 210.

The input data may be data related to a character. In some embodiments, the input data may include at least one of description data or deduction data of the character.

The description data is data that defines a feature of the character. For example, the description data may include information such as age, gender, birth era, occupation, personality, etc., of the character. As another example, the description data may directly define the character as a specific celebrity or family friend.

In some embodiments, the input data obtaining module 210 may obtain the description data input by a user via the user terminal 120. For example, the user may input the description data to a user terminal by a voice: “a 30-year-old male high school math teacher with a humorous and interesting teaching style,” “a technician in the field of artificial intelligence technology,” etc. As another example, the user may input the description data to the user terminal via a text: “Li Bai of 30-year-old,” “a user A with a social account 12345,” etc.

The deduction data is data that reflects features of the character. For example, the deduction data may include, but is not limited to, an image of the character (e.g., a portrait, a poster, a photograph, a cartoon image, etc.), a video (e.g., an instructional video, an interview footage, etc.), an audio (e.g., a conversation, a speech, etc.), social media dynamics (e.g., photos on social media, Instagram updates, etc.), and a work (a literary work, an artistic work, a scientific paper, etc.).

In some embodiments, the input data obtaining module 210 may obtain the deduction data input by the user via the user terminal 120. For example, the user may upload the deduction data of the character via the user terminal. As another example, the user may input a database interface of the deduction data to the user terminal, and the input data obtaining module 210 may access the deduction data of the character based on the database interface of the deduction data.

In some embodiments, the input data obtaining module 210 may obtain corresponding deduction data based on the description data of the character. Specifically, the input data obtaining module 210 may determine a corresponding target data source and a target mining strategy based on the description data of the character.

The target data source may be a data source used to obtain the deduction data. In some embodiments, the input data obtaining module 210 may pre-set a corresponding relationship between the deduction data and the target data source. Merely by way of example, based on the occupation of the character, it may be determined that the target data source includes at least a knowledge database corresponding to a field of the occupational. As another example, based on a particular character, it may be determined that the target data source includes at least an expressive work database of the particular character. For example, based on the description data “30-year-old male high school math teacher with a humorous teaching style,” it may be determined that the target data source includes at least an instructional video database, or based on the description data “technical personnel in the field of artificial intelligence technology,” it may be determined that the target data source includes at least a patent database and an academic database. As another example, based on the description data “30-year-old Li Bai,” it may be determined that the target data source includes at least a database of Li Bai's works, or based on the description data “a user A with a social account 12345,” it may be determined that the target data source includes at least social media dynamics of the user A.

The target mining strategy may be a strategy for obtaining the deduction data. The target mining strategy may at least include an associated feature. The associated feature may be a feature associated with the description data, e.g., the description data “30-year-old male high school math teacher with a humorous teaching style” may correspond to associated features such as “30-year-old,” “male math teacher,” and “humor.”

Further, the input data obtaining module 210 may obtain the deduction data of the character from the target data source based on the target mining strategy. For example, the input data obtaining module 210 may mine an instructional video that meets any one of the associated features of “30-year-old,” “math male teacher,” or “humor” from the instructional video database as the deduction data.

Embodiments of the present disclosure may realize that when the user's input data is description data containing little information, more deduction data can be mined based on the description data through big data mining, so as to improve the richness of the input data and provide sufficient information for the subsequent generation of the virtual human.

In some embodiments, the deduction data may include an object image. In some embodiments, the input data obtaining module 210 may obtain the object image by shooting the object with a shooting device.

The shooting device is configured to shoot to acquire an image, which may be various devices that can be used for shooting an image. More specifics about the shooting device and the image can be found in FIG. 1 and its related description. In some embodiments, the shooting device may be triggered to perform image shooting in various ways. For example, the shooting device receives an instruction to perform image shooting (e.g., the user terminal triggers a shooting function based on user input, and at this time, a processor of the user terminal may send an instruction to the shooting device to trigger the shooting device to perform image shooting), or the shooting device may be triggered to perform image shooting automatically when monitoring certain events (e.g., the shooting device has a trigger switch such as a mechanical trigger switch or a sensor trigger switch, so that the shooting device may be automatically triggered to shoot an image when the user or an external force is monitored to trigger the mechanical trigger switch, or the sensor monitors a signal to trigger the sensor trigger switch, etc.).

An image captured by the shooting device that includes an object in an environment is called the object image. It may be appreciated that objects in the environment may include a variety of entities that may be present, such as paintings, sculptures, images displayed on a display medium (e.g., images on a display screen, etc.), people, icons, or the like.

The processor may obtain the object image shot by the shooting device and display the object image on a display interface of the terminal device. The processor may display the object image on the display interface of the terminal device in various feasible ways. For example, when the terminal device comprises the processor, the processor may send an instruction and image information to the display of the terminal device, thereby controlling the display interface of the display to display the object image.

In some embodiments, the object image may be displayed on the display interface at a suitable size, such as the object image being displayed full-screen on the display interface, the object image being displayed on the display interface at a preset size, or the like. In some embodiments, a manner in which the object image is displayed on the display interface, such as the size, may be set by the user as desired.

In some embodiments, the object image obtained by the processor and the object image displayed on the display interface may be a single-frame image shot by the shooting device, or a video image obtained by the shooting device shooting continuously.

In step 320, feature data of the character is obtained based on the input data. In some embodiments, step 320 may be performed by the feature data obtaining module 220.

The feature data may be data that reflects a feature of the character.

In some embodiments, the feature data of the character may at least include an expression feature of the character. The expression feature may reflect thoughts and habits expressed by the character. Merely by way of example, the expression feature may reflect the character's opinions, knowledge, attitudes, speed of speech, intonation, habits of speech, voice inflections, etc. For example, when the input data includes the description data “30-year-old Li Bai” and its corresponding deduction data, the expression feature may reflect the character's viewpoint of “timely happiness”; and when the input data includes the description data “30-year-old Du Fu” and its corresponding deduction data, the expression feature may reflect the character's viewpoint of “sadness and compassion for the people.” As another example, when the input data includes the description data “30-year-old male high school math teacher” and its corresponding deduction data, the expression feature may reflect that knowledge of the character in mathematics is “knowledge and principles of high school mathematics,” and when the input data includes description data “mathematician” and its corresponding deduction data, the expression feature may reflect that the knowledge of the character in mathematics is “familiar with all mathematical results in the field of mathematics and have certain mathematical problem discovery abilities.” As a further example, when the input data includes the description data “a user A with a social account number 12345” and its corresponding deduction data, the expression feature may reflect the character's habit of saying “right?” at the end of each sentence.

In some embodiments, the feature data of the character may also include a portrait feature of the character. The portrait feature may be a feature that reflects an image of the character (also referred to as a character image). For illustrative purposes only, the portrait feature may include a portrait type, a portrait facial feature, a portrait color feature, a portrait clothing feature, a portrait size, or the like. For example, when the input data includes the description data “30-year-old Li Bai” and its corresponding deduction data, the portrait feature may reflect at least the portrait clothing feature of the character as the clothing of a 30-year-old man in the Tang Dynasty.

In some embodiments, the feature data of the character may also include a facial expression feature and an action feature of the character. The facial expression feature may reflect a facial expression of the character's emotions. Merely by way of example, the facial expression feature may include an emotional feature (e.g., excited, happy, angry, calm, etc.) and a facial expression feature (e.g., forbearance, exposure, exaggeration, etc.). The action feature may be a feature that reflects the character's habitual action. Merely by way of example, the action feature may include a gesture feature (e.g., OK gesture, goodbye gesture, etc.) and a dynamic degree feature (e.g., large magnitude, small magnitude, etc.).

In some embodiments, the feature data obtaining module 220 may obtain the feature data of the character based on the description data. Specifically, the processor may store, in a storage device, feature data corresponding to different genders, birth eras, occupations, personalities, or the like in the description data. For example, based on historical description data “30-year-old,” the processor may obtain corresponding historical deduction data and store historical feature data determined based on the historical deduction data as the feature data corresponding to the “30-year-old.” Further, the feature data obtaining module 220 may obtain corresponding feature data from the storage device based on the current description data “30-year-old.”

In some embodiments, the feature data obtaining module 220 may obtain the feature data of the character based on the deduction data. Specifically, the feature data obtaining module 220 may filter the deduction data to obtain the deduction feature. Exemplarily, the feature data obtaining module 220 may first vectorize the deduction data, then cluster the deduction data based on each feature label (e.g., expression, image, facial expression, action, etc.) to obtain at least one label dataset, determine a plurality of central locations in each label dataset as corresponding central features, and filter the deduction data that is more than a threshold distance away from the central feature to obtain at least one deduction feature. In some embodiments, the clustering may include but is not limited to, a combination of one or more of the following algorithms: a K-MEANS clustering algorithm, a mean shift clustering algorithm, a density-based spatial clustering of applications with noise (DBSCAN) clustering algorithm, or the like. In some embodiments, the feature data obtaining module 220 may also filter the deduction data by a consistency check, a model detection, a deletion of missing values, a mean-filling, a hot-card-filling, a split-box method, or the like, which is not limited in the embodiments of the present disclosure.

Further, the feature data obtaining module 220 may obtain the feature data of the character based on the deduction feature. Merely by way of example, the feature data obtaining module 220 may utilize a feature extraction module corresponding to each feature label (e.g., expression, image, facial expression, action, etc.) to extract feature data of the character from corresponding deduction features. For example, an expression feature extraction module may be utilized to extract the expression feature of the character from deduction features corresponding to the expression, and a portrait feature extraction module may be utilized to extract the portrait feature of the character from deduction features corresponding to the image. In some embodiments, the feature extraction module may include, but is not limited to, a convolutional neural network (CNN) model, a recurrent neural network (RNN) model, a long short-term memory (LSTM) model, an attention model, a transformer model, etc., or a combination thereof.

As another example, the feature data obtaining module 220 may utilize a feature extraction model to extract the feature data of the character from the at least one deduction feature. For example, the at least one deduction feature (e.g., a deduction feature corresponding to expression, a deduction feature corresponding to image, etc.) is input into the feature extraction model, and the feature extraction model outputs the expression feature, the portrait feature, etc. In some embodiments, the feature extraction model may include, but is not limited to, one or a combination of a bi-directional long short-term memory (Bi-LSTM) model, an embedding from language model (ELMo), a generative pre-traxining (GPT) model, a bidirectional encoder representation from transformers (BERT) model, etc.

Embodiments of the present disclosure may generate the feature data of the character based on the deduction data, enabling the feature data to characterize the character's feature in a more graphic and three-dimensional manner, thereby making a subsequently-generated virtual human more anthropomorphic and vivid.

In some embodiments, the feature data of the character may include a portrait of the character. In some embodiments, the feature data obtaining module 220 may process an obtained object image to recognize the portrait of the character included in the object image.

The portrait included in the object image may include various types of portraits. In some embodiments, specifically, types of the portrait included in the object image may include a real character image, a painted character image, a character image in icon design, or the like. The real character image refers to an image corresponding to a real character, such as a photo of the real character, etc. The painted character image refers to a character image painted or shown in graphic works such as oil paintings, sketches, statues, etc. The character image in icon design refers to a character image shown in an icon design such as various shapes of logos, posters, or the like (which may include a simulated character image, a character image that is further changed or designed based on the real character image, etc.).

In addition, it is understood that the recognized portrait may include a variety of possible character images, such as character images of great historical figures, celebrity figures, user's relatives and family members, etc., or character images such as cartoons, designed graphics, and artistically created portraits. Thus, the portrait type may also include the above-mentioned different character images. In some embodiments, the recognition of whether the portrait belongs to a historical great figure, a celebrity figure, a relative and family member of the user, a cartoon, etc., may be realized based on constructing a database including various character images and matching the character images in the database.

In some embodiments, the processor may process the object image through a variety of feasible image recognition algorithms to recognize the portrait included in the object image.

Merely by way of example, the processor may extract an image feature such as a background feature, a color feature, an object contour feature in the image, a facial feature (such as a facial contour, facial textures, and other facial-related features) of a character contour in an object contour of the object image by an image feature extraction algorithm. The processor may determine, based on the extracted image feature, whether the object image includes a portrait (for example, a similarity between an object contour feature and a portrait contour feature in the image is greater than a threshold value, e.g., 80%, etc.), and a type to which the portrait included in the object image belongs, e.g., whether the type is one of a variety of types such as the real character image, the painted character image, the character image in icon design, etc. For example, if a similarity between a facial feature of the portrait in the image and a facial feature of the real character is greater than a threshold value such as 80%, the portrait type is the real character image. If a similarity between a picture feature of a picture around a position where the portrait is located in the image and a background feature of the background and a paint feature is greater than a threshold value such as 80%, the portrait type is the painted character image. If a similarity between a picture feature of a picture around a position where the portrait is located in the image and a background feature of the background and an icon design feature is greater than a threshold value such as 80%, the portrait type is the character image in icon design.

As another example, the processor may also process the object image by an image recognition model to identify the portrait included in the object image and the type to which the portrait belongs, for example, the portrait type is one of the types of the real character image, the painted character image, the character image in icon design, and so on. The image recognition model may be one or a combination of various available networks such as a convolutional neural network (CNN), a deep neural network (DNN), etc., and wherein the image recognition model may be trained (which may be trained by various machine learning training methods) with image samples labeled with a label (including the portrait included in the object image and the type to which the portrait belongs), such that the image recognition model may output to obtain the portrait included in the object image and the type to which the portrait belongs based on an inputted object image.

In step 330, a corresponding virtual human may be generated based on the feature data of the character and the virtual human may be dynamically displayed on a display interface. In some embodiments, step 330 may be performed by the virtual human generating and displaying module 230.

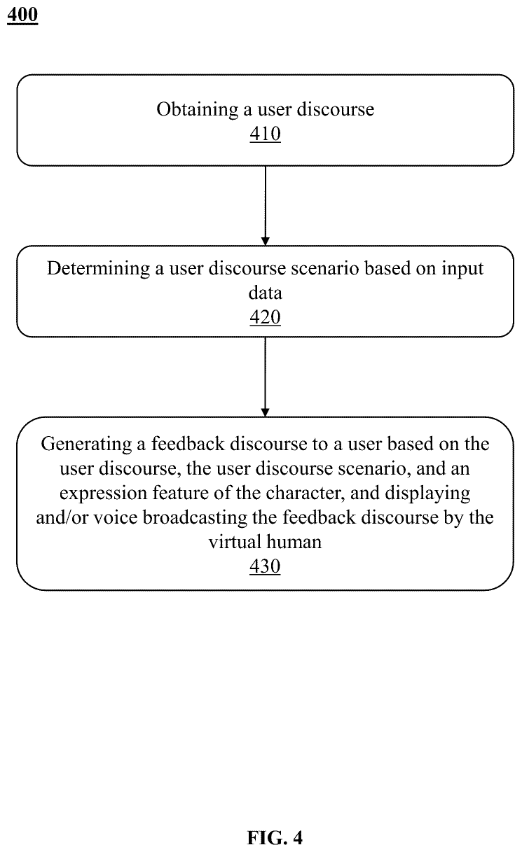

In some embodiments, the processor may drive the virtual human and the user to engage in a conversation. In some embodiments, the processor may obtain a user discourse (e.g., the user discourse is obtained via a voice capture device of a terminal device and transmitted to the processor), and the processor may generate a feedback discourse to the user and drive the virtual human to display the feedback discourse and/or play the feedback discourse through voice broadcast. More specifics about driving the virtual human and the user to engage in a conversation can be found in FIG. 4 and its related descriptions.

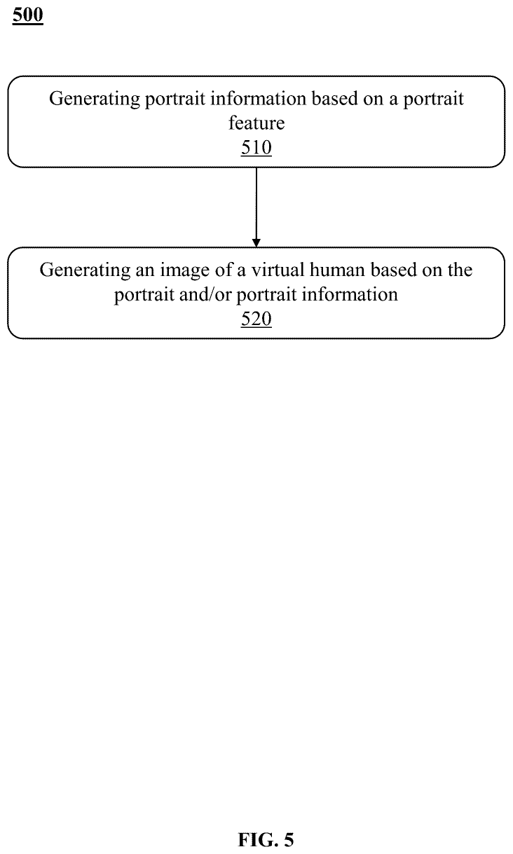

In some embodiments, the processor may generate the virtual human through various feasible virtual human modeling techniques, such as a virtual human image base may be obtained through virtual human face and body modeling techniques. More specifics regarding the generation of the virtual human image base can be found in FIG. 5 and its related descriptions.

In some embodiments, the processor may also drive the virtual human to make facial expressions and actions, add more rendering effects to the virtual human, or the like, through techniques such as driving and rendering.

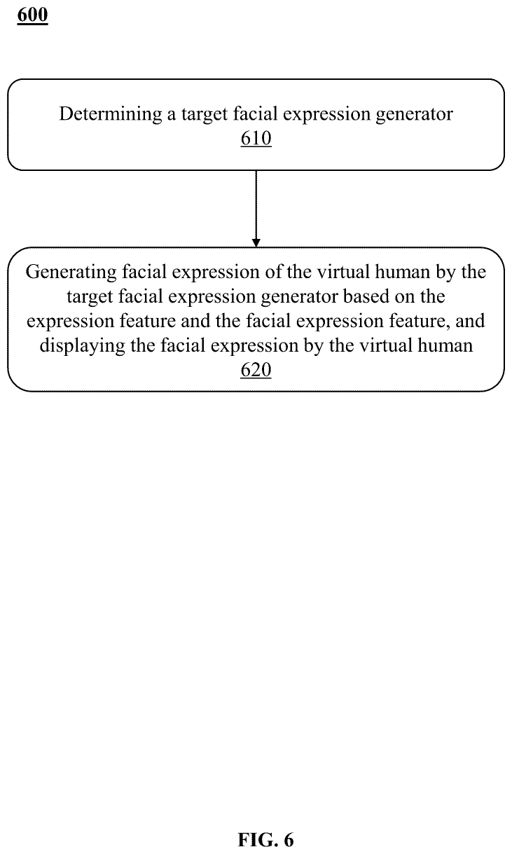

In some embodiments, the generation of the virtual human may include generating facial expressions of the virtual human via a facial expression generator. More specifics regarding the generation of facial expressions of the virtual human can be found in FIG. 6 and its related descriptions.

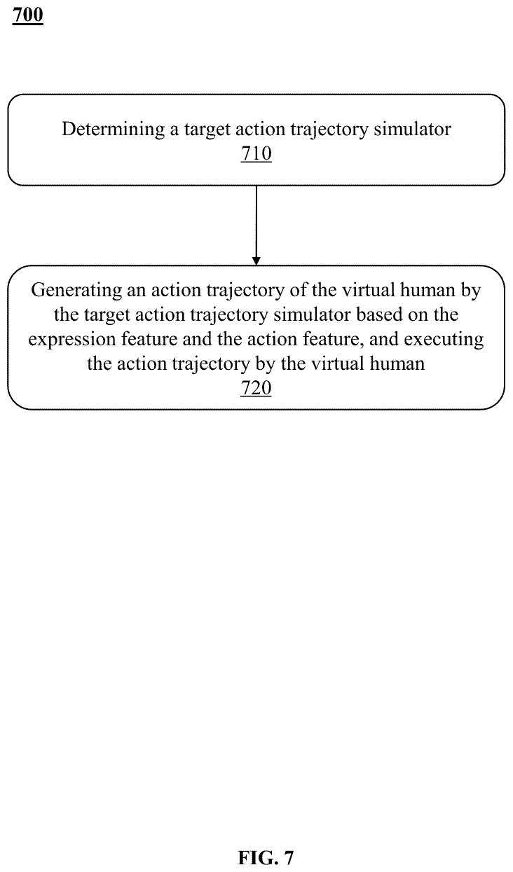

In some embodiments, the generation of the virtual human may include generating an action trajectory of the virtual human via an action trajectory simulator. More specifics regarding the generation of the action of the virtual human can be found in FIG. 7 and its related descriptions.

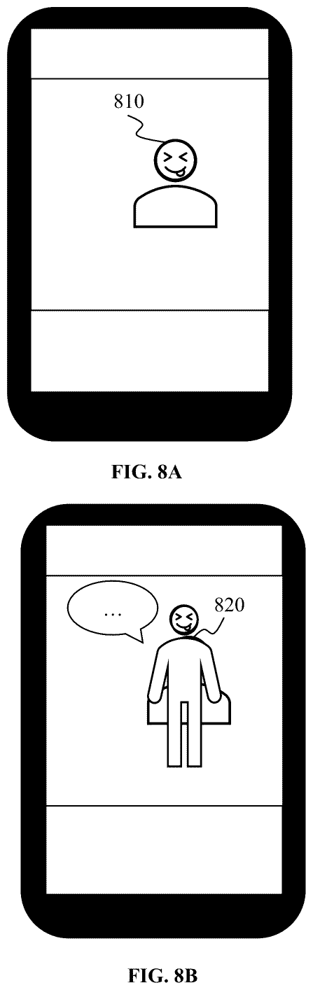

In some embodiments, the generated virtual human may be dynamically displayed on the display interface. More specifics regarding dynamically displaying the virtual human on the display interface can be found in FIG. 8A, FIG. 8 B, and their related descriptions.

Through process 300, the virtual human is generated based on the expression feature, which can make the generated virtual human have thoughts, viewpoints, and personalities that meet the user's requirements, making the virtual human more anthropomorphic and personalized.

FIG. 4 is a flowchart illustrating an exemplary process for driving a virtual human to engage in a dialogue and a user according to some embodiments of the present disclosure. In some embodiments, a process 400 may be executed by the processor 110. In some embodiments, the process 400 may be realized by the system 200 on the processor 110 (e.g., the virtual human generating and displaying module 230). The process 400 may include the following steps.

In step 410, a user discourse is obtained.

The user discourse may be a dialog and/or language expressed by a user. The user discourse may be a speech, a text, a sign language, etc. In some embodiments, the processor may obtain the user discourse from the user terminal 120.

In step 420, a user discourse scenario is determined based on input data.

The user discourse scenario may reflect the user's intention to a certain extent. For example, the user discourse scenario may be a dialogue with a real character, a dialogue with a painted character, a dialogue with a character in icon design, etc. As another example, the user discourse scenario may be a dialogue with a historical character, a dialogue with a relative, a dialogue with a celebrity figure, a dialogue with a teacher, etc. As a further example, the user discourse scenario may be a dialogue with a creative character, etc. When the user discourse scenario is the dialogue with the real character or the dialogue with the relative, a user discourse intention may tend to be a daily life-related dialogue; when the user discourse scenario is the dialogue with the painted character, the dialogue with the historical character, or the dialogue with the teacher, the user discourse intention may tend to be a knowledge-acquisition-related dialogue; when the user discourse scenario is the dialogue with the character in icon design, or the dialogue with the celebrity character, the user discourse intention may tend to be a publicity and introduction-related dialogue (e.g., the introduction of products, celebrity figures, etc.); and when the discourse scenario is the dialogue with the creative character, the user discourse intention may tend to be a dialogue related to literary and artistic works.

In some embodiments, the processor may determine the user discourse scenario based on the input data. For example, a character's occupation and education may be determined based on description data, and the processor may determine the user discourse scenario based on the character's occupation and education. As another example, one or more types of information such as portrait information (e.g., one or more portrait-related feature information such as the portrait type, the portrait facial feature, the portrait color feature, the portrait clothing feature, the portrait size, etc.), scenario information (e.g., background environment information, etc.), etc., may be obtained based on an object image, and the processor may determine the user discourse scenario based on the image information.

In step 430, based on the user discourse, the user discourse scenario, and an expression feature of the character, a feedback discourse is generated to the user, and the feedback discourse is displayed and/or voice broadcast by the virtual human.

In some embodiments, the processor may generate the feedback discourse to the user based on the obtained user discourse, the user discourse scenario, and the expression feature of the character. In some embodiments, specifically, the processor may determine a knowledge base based on the character's expression feature. The knowledge base refers to a collection of knowledge points. The knowledge point may be composed of a statement to be fed back and a feedback statement corresponding to the statement to be fed back. The user's discourse such as questions may belong to the statement to be fed back, and a feedback discourse to the user's discourse may belong to the feedback statement corresponding to the statement to be fed back. The processor may find all knowledge points (called relevant knowledge points, which may include one or more) related to the content of the user's discourse in the knowledge base based on the user's discourse, wherein the knowledge points related to the content of the user's discourse may refer that there are one or more of identical words between the knowledge points and the content of the user's discourse. Further, the processor may determine a semantic representation vector (referred to as a scenario semantic representation vector) corresponding to the user discourse scenario based on the user discourse scenario, determine an utterance representation vector (referred to as an utterance representation vector) of the user discourse based on the user discourse, and determine an utterance representation vector of the statement to be fed back of the relevant knowledge points based on the user discourse scenario and the character's expression feature (referred to as a relevant knowledge point utterance representation vector). The processor may calculate a similarity (called a first similarity) between the scenario semantic representation vector and each relevant knowledge point utterance representation vector, and a similarity (called a second similarity) between the utterance representation vector and each relevant knowledge point utterance representation vector through a similarity algorithm. The processor may get a score of each relevant knowledge point based on the first similarity and the second similarity (e.g., based on the average, sum, weighted sum of the first similarity and the second similarity), and rank all relevant knowledge points based on the scores, so that the relevant knowledge point with the highest order in the ranking may be used as the knowledge point that ultimately matches the content of the user's discourse and user's discourse scenario. In turn, the processor may use a feedback statement in the identified matching knowledge point as the feedback discourse to the user discourse.

Through process 400, it can be realized that the feedback discourse broadcast by the virtual human can express the virtual human's viewpoints, thoughts, and personalities, which makes the virtual human more personalized.

FIG. 5 is a flowchart illustrating an exemplary process for generating an image of a virtual human according to some embodiments of the present disclosure. In some embodiments, a process 500 may be executed by the processor 110. In some embodiments, the process 500 may be realized by the system 200 on the processor 110 (e.g., the virtual human generating and displaying module 230). The process 500 may include the following steps.

In step 510, portrait information is generated based on a portrait feature.

As mentioned above, the portrait feature may be a feature reflecting an image of a character. The portrait information may be feature information of an image of a virtual human. In some embodiments, the portrait information includes at least one of the following: a portrait type (such as a type of a real character image, a painted character image, a character image in icon design, or the like), a portrait facial feature, a portrait color feature, a portrait clothing feature, and a portrait size.

Specifically, the virtual human generating and displaying module 230 may generate a corresponding portrait type, a corresponding portrait facial feature, a corresponding portrait color feature, a corresponding portrait clothing feature, and a corresponding portrait size based on a character type, a character facial feature, a character color feature, a character clothing feature, a character size, etc.

In step 520, the image of the virtual human is generated based on the portrait and/or portrait information.

In some embodiments, after recognizing that a portrait is included in the object image, the processor may obtain portrait information of the portrait in the object image.

In some embodiments, the processor may combine one or more of the foregoing portrait information to generate a virtual human corresponding to the character. For example, in some embodiments, an image type of a generated virtual human may correspond to a portrait type, such as if the portrait type is the real character image, the virtual human's image is similar or close to a real character (i.e., has a sense of realism). As another example, if the portrait type is the painted character image, the virtual human's image type is also the painted character image. As another example, if the portrait type is the character image in icon design, the virtual human's image type is also the character image in icon design. In some embodiments, the generated virtual human may also share common or similar portrait facial features, portrait color features, and portrait clothing features with the character. In some embodiments, the size of the generated virtual human may be determined based on the portrait size, e.g., the size of the generated virtual human may be the same size as the portrait size in the object image or may be proportional to the portrait size in the object image (e.g., 1:1.2, 1:1.5, 0.8:1, etc.). In some embodiments, a ratio of the portrait size to the size of the virtual human may be determined based on the size of the display interface.

In some embodiments, a library of prefabricated virtual humans may be stored in a storage device, which may include one or more virtual humans that have been prefabricated in advance. Each virtual human may have its corresponding image type, facial feature, color feature, clothing feature, size, and other features. The processor may also obtain a virtual human corresponding to the identified portrait from the library of prefabricated virtual humans based on obtained portrait information.

Through the process 500, it is possible to obtain the image of the virtual human that meets different requirements of the user based on portrait features corresponding to the input data in different ways, thereby satisfying the user's personalized needs.

FIG. 6 is a flowchart illustrating an exemplary process for generating a facial expression of a virtual human according to some embodiments of the present disclosure. In some embodiments, a process 600 may be executed by the processor 110. In some embodiments, the process 600 may be implemented by the system 200 on the processor 110 (e.g., the virtual human generating and displaying module 230). The process 600 may include the following steps.

In step 610, a target facial expression generator is determined.

In some embodiments, a virtual human may have a variety of facial expression patterns, such as happy, sad, calm, and so on, and each pattern may correspond to a facial expression generator for generating the facial expression of the virtual human in that pattern.

The facial expression generator may generate a corresponding facial expression vector representation based on an expression feature and a facial expression feature. The facial expression vector representation may be specifically an AU intensity vector, wherein multiple local facial muscles correspond to multiple AUs (action units). Each AU has multiple intensity levels such as 0-6, each facial expression may be represented by multiple AU intensities, and the multiple AU intensity representations may constitute an AU intensity vector. The processor may then drive the virtual human to make a corresponding facial expression based on the facial expression vector representation. In some embodiments, an utterance representation vector corresponding to a disclosure, and an image scenario feature vector corresponding to image scenario information may also be input into the facial expression generator.

In some embodiments, the facial expression generator may be implemented by various feasible models such as CNN, DNN, and other models. The facial expression generator may be trained by a machine learning method based on sample data (various expression feature samples, various facial expression feature samples, various discourse samples, and image scenario features corresponding to various frames) and facial expression labels corresponding to the sample data (which may be expression vector representations of facial expressions of real faces corresponding to sample data captured on real faces), such that the facial expression generator may generate a corresponding facial expression vector representation based on the expression features, facial expression features, discourses, and image scenario features. Moreover, each facial expression pattern may be trained separately for a corresponding facial expression generator. For example, each facial expression pattern corresponds to a class of sample data and facial expression labels, and a corresponding facial expression generator may be obtained by training based on the class of sample data and facial expression labels.

In some embodiments, a target facial expression pattern may be specified by the user among a plurality of facial expression patterns. In some embodiments, the processor may match the corresponding pattern among multiple facial expression patterns according to a matching method, such as a preset rule, as the target facial expression pattern based on the portrait information. Various types of portrait information may be pre-categorized into a certain facial expression pattern, thereby forming a library of portrait information corresponding to the various facial expression patterns. The preset rule may be to match the portrait information with multiple pre-divided portrait information libraries, and after determining the portrait information library that matches therewith, the facial expression pattern corresponding to the matched portrait information library is the determined target facial expression pattern, thereby determining the corresponding target facial expression generator.

In step 620, the facial expression of the virtual human is generated by the target facial expression generator based on the expression feature and the facial expression feature, and the facial expression is displayed by the virtual human.

In some embodiments, after determining the target facial expression generator, the facial expression of the virtual human may be generated by the target facial expression generator based on the expression feature and the facial expression feature (e.g., the expression feature, the facial expression feature, the utterance representation vector corresponding to the disclosure, the image scenario feature vector corresponding to the image scenario information are inputted into the target facial expression generator, and the target facial expression generator outputs a corresponding facial expression vector representation), and the processor drives the virtual human to display the facial expression.

Through process 600, it can be realized to generate the facial expression of the virtual human that is more compatible with the character's features and thoughts, which makes the user's interaction with the virtual human more realistic and immersive and improves the user experience.

FIG. 7 is a flowchart illustrating an exemplary process for generating an action of a virtual human according to some embodiments of the present disclosure. In some embodiments, a process 700 may be executed by the processor 110. In some embodiments, process 700 may be realized by the system 200 on the processor 110 (e.g., the virtual human generating and displaying module 230). The process 700 may include the following steps.

In step 710, a target action trajectory simulator is determined.

In some embodiments, a virtual human may have a variety of actions, such as OK, goodbye, and other actions of the hand, shaking head, nodding head, and other actions of the head. Each action may correspond to a kind of action trajectory simulator for generating a kind of virtual human to perform such kind of action trajectory.

Specifically, the action trajectory simulator may be used to generate a corresponding action vector representation based on an expression feature and an action feature. For example, the expression feature and the action feature are input into the action trajectory simulator, and the action trajectory simulator outputs a corresponding action vector representation. In some embodiments, an utterance representation vector corresponding to a discourse, and an image scenario feature vector corresponding to image scenario information may also be input into the action trajectory simulator. Similar to the facial expression vector representation, an action vector representation may be specifically an AU intensity vector, wherein a plurality of localized muscles at a plurality of sites corresponds to a plurality of AUs (action units), and each AU has a plurality of intensity levels such as 0-6, each action may be represented by a plurality of sequential AU intensities, and the plurality of sequential AU intensity representations may constitute an AU intensity vector. The processor may then drive the virtual human to make a corresponding action based on the action vector representation.

In some embodiments, the action trajectory simulator may be implemented by various feasible models such as CNN, DNN, and other models. The action trajectory simulator may be trained based on sample data (various expression feature samples, various action feature samples, various discourse samples, and image scenario features corresponding to various frames) and action labels corresponding to the sample data (which can be action vector representations of real actions corresponding to the sample data captured for real actions) by a machine learning method, such that the action trajectory simulator may generate corresponding action vector representations based on expression features, action features, disclosures, and image scenario features. Moreover, each action trajectory may be trained separately for a corresponding action trajectory simulator. For example, each action trajectory corresponds to a class of sample data and action labels, and a corresponding action trajectory simulator may be obtained by training based on the class of sample data and action labels.

In some embodiments, the target action trajectory simulator may be determined based on the user's operation information. In some embodiments, a terminal device may obtain a user operation on the virtual human on a display interface, such as clicking (single click, consecutive multiple clicks, etc.), touching (short time touching less than a time threshold, long time touching greater than or equal to a time threshold, etc.), sliding, and various other operations. The operation information obtained by the terminal device may be transmitted to the processor, and the processor may determine the target action trajectory simulator based on the operation. Specifically, the processor may match the corresponding action trajectory among the multiple action trajectory simulators according to the user operation based on a matching method such as a preset rule, as the target action trajectory. Information of various types of user operations may be pre-categorized in a certain kind of action trajectory, so as to form a library of user operation information corresponding to the various kinds of action trajectories. The preset rule may be to match the user operation information with multiple pre-divided user operation information libraries, and after determining the user operation information library that matches therewith, an action trajectory corresponding to the matched user operation information library is the determined target action trajectory, thereby determining the corresponding target action trajectory simulator.

In step 720, an action trajectory of the virtual human is generated by the target action trajectory simulator based on the expression feature and the action feature, and the action trajectory is executed by the virtual human.

In some embodiments, after determining the target action trajectory simulator, the action trajectory of the virtual human may be generated based on the expression feature and the action feature through the target action trajectory simulator (e.g., inputting the expression feature, the action feature, an utterance representation vector corresponding to the discourse, and the image scenario feature vector corresponding to the image scenario information into the target action trajectory simulator, and the target action trajectory simulator output the corresponding action vector), and the processor drives the virtual human to execute the action trajectory, thus realizing the virtual human action interaction based on user vision.

In some embodiments, the processor may, in response to obtaining a predetermined target operation by the user (which may be, for example, a user action that is suspected of unclear intent or reflected as a haphazard operation such as multiple consecutive clicks, a prolonged touch, or other similar user actions), trigger the presentation of a dialog box on the display interface, and trigger the virtual human to make a sign language action to express a conversation that guides the user to use the dialog box. Through this embodiment, the user operation that is suspected of unclear intent or reflected as a haphazard operation can be recognized, at which time it can be considered that the user doesn't know how to use the virtual human interaction function (e.g., voice interaction) or the user cannot use the voice interaction function (e.g. if the user is a disabled person or a patient who is unable to speak, etc.), the processor may automatically trigger the presentation of the dialog box and the guidance of the virtual human sign language action, thereby effectively helping and guiding the user to use the virtual human interaction function and improving the user's experience.

Through process 700, it is possible to realize the generation of the action of the virtual human that is more adapted to the character's features and thoughts, which makes the user's interaction with the virtual human more realistic and immersive and improves the user experience.

FIG. 8A and FIG. 8B are schematic diagrams illustrating exemplary display interfaces of virtual human-based interaction according to some embodiments of the present disclosure. As shown in FIG. 8A, an object image is displayed on a display interface, which includes a portrait 810. As shown in FIG. 8B, a virtual human 820 corresponding to the portrait 810 is displayed on the display interface.

A position on the display interface where a portrait (e.g., the portrait 810) is located is referred to as a target position. In some embodiments, the processor may determine to indicate and/or control the presence of a virtual human (e.g., the virtual human 820) at the target position where the portrait (e.g., the portrait 810) on the display interface is located. It can be understood that the virtual human displayed on the display interface can partially cover or completely cover the portrait in the object image. In this way, the sense of realism and immersion of the virtual human replacing the portrait in the object image for interaction with users can be strengthened, avoiding having too many portraits when both portraits in the object image and the virtual human appear simultaneously, which can interfere with user visual experience and affect the user's interaction experience.

In some embodiments, the virtual human may appear in a dynamic generation manner, wherein the dynamic generation manner means that the virtual human changes dynamically during the emergence process from scratch. In some embodiments, the dynamic generation manner includes any one or a combination of: the virtual human appears through a dynamic change in size, and the virtual human appears through a dynamic change in position. The dynamic change in size refers to a way such as increasing in size, constantly switching sizes, or decreasing in size (it should be noted that the virtual human appearing after the dynamic change in size may be displayed in a fixed size), and the dynamic change in position refers to reaching the target position in the form of jumping out, flying out, popping out, etc.

In some embodiments, the size of the virtual human displayed on the display interface may also be determined based on the size of the display interface. For example, the size of the virtual human may be positively correlated with a horizontal length or a vertical length of the display interface, i.e., the larger the horizontal length and/or the vertical length of the display interface, the larger the size of the virtual human may be. Through this embodiment, it is possible to make more adaptive adjustments to the size of the virtual human according to the size of the display interface, so as to make the virtual human have a better display effect on various sizes of the display interfaces.

In some embodiments, when a terminal device of a user includes a shooting device, the processor may construct an environment map based on an environment image captured by the shooting device by means of an environment modeling technique (e.g., an environment map construction technique such as SLAM). According to the environment map modeling technique, the processor may determine a position (referred to as a terminal position) of the terminal device in the constructed environment map, and a position (referred to as a first position) in the constructed environment map corresponding to a screen placement position of the virtual human in the display interface. It can be understood that a screen of the display interface shows an image captured by the shooting device, and each image position in the screen corresponds to a position in the constructed environment map. Thus, a screen placement position of the virtual human in the display interface corresponds to an image position which corresponds to a position in the environmental map, i.e., the first position. In some embodiments, the terminal device may undergo a change in position, for example, the user holds the terminal device for movement. The processor may adjust the first position according to the change in position of the terminal position, so as to adjust the virtual human's screen placement position in the display interface according to the adjusted first position. At the same time, the processor may maintain a first distance between the first position and the terminal position, which may be a preset distance such as 1 m, 1.5 m, etc.

It should be understood that the first distance between the first position and the terminal position is a distance in the environmental map. The first distance manifested in the display interface may be that the screen placement position of the virtual human has a certain distance from a scenery near the terminal position in the screen, i.e., the user visually appears to have a better integration of the virtual human and a real image in the screen, and the virtual human is more realistic. The embodiment realizes the enhancement of the sense of realism and immersion of the user's interaction with the virtual human.

It should be noted that different embodiments may have different beneficial effects. In different embodiments, the possible beneficial effects may be any one or a combination of the above, or any other possible beneficial effects.

The basic concepts have been described above, and it is apparent to those skilled in the art that the detailed disclosure serves Merely by way of example and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure. Such as “an embodiment,” “one embodiment,” and/or “some embodiments” means a feature, structure, or characteristic associated with at least one embodiment of the present disclosure. Accordingly, it should be emphasized and noted that “one embodiment” or “an embodiment” or “an alternative embodiment” in different places in the present disclosure do not necessarily refer to the same embodiment. In addition, certain features, structures, or characteristics of one or more embodiments of the present disclosure may be suitably combined.

Additionally, unless expressly stated in the claims, the order of the processing elements and sequences, the use of numerical letters, or the use of other names as described in the present disclosure are not intended to qualify the order of the processes and methods of the present disclosure. While a number of embodiments are discussed in the above disclosure by way of various examples that are presently considered useful, it should be understood that such detail serves an illustrative purpose only, and the additional claims are not limited to the disclosed embodiments. Rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that in order to simplify the presentation of the disclosure of the present disclosure, and thereby aid in the understanding of one or more embodiments, the preceding description of embodiments of the present disclosure sometimes combines a variety of features into a single embodiment, accompanying drawings, or a description thereof. However, this method of disclosure does not imply that the objects of the present disclosure require more features than those mentioned in the claims. Rather, claimed subject matter may lie in less than all features of a single foregoing disclosed embodiment.

Some embodiments use numbers describing the number of components, attributes, and it should be understood that such numbers used in the description of the embodiments are modified in some examples by the modifiers “about,” “approximately,” or “substantially.” Unless otherwise noted, the terms “about,” “approximately,” or “substantially” indicate that a ±20% variation in the stated number is allowed. Correspondingly, in some embodiments, the numerical parameters used in the present disclosure and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments, such values are set to be as precise as possible within a feasible range.

For each of the patents, patent applications, patent application disclosures, and other materials cited in the present disclosure, such as articles, books, specification sheets, publications, documents, or the like, are hereby incorporated by reference in their entirety into the present disclosure. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those set forth herein, the descriptions, definitions, and/or use of terms in the present disclosure shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be considered to be consistent with the teachings of the present disclosure as an example, not as a limitation. Correspondingly, the embodiments of the present disclosure are not limited to the embodiments expressly presented and described herein.

What is claimed is:

1. A virtual human-based interaction method, comprising
obtaining input data, the input data including at least one of description data or deduction data of a character;
obtaining feature data of the character based on the input data, the feature data of the character at least includes an expression feature of the character;
generating a virtual human based on the feature data of the character; and
dynamically displaying the virtual human on a display interface.

2. The method of claim 1, wherein the obtaining input data includes:
determining a target data source and a target mining strategy based on the description data of the character, wherein the target mining strategy at least includes an associated feature; and
obtaining the deduction data of the character from the target data source based on the target mining strategy.

3. The method of claim 1, wherein the obtaining the feature data of the character based on the input data includes:
obtaining a deduction feature by filtering the deduction data; and
obtaining the feature data of the character based on the deduction feature.

4. The method of claim 1, wherein the generating a virtual human based on the feature data of the character and dynamically displaying the virtual human on a display interface includes:
obtaining a user discourse;
determining a user discourse scenario based on the input data;
generating a feedback discourse to a user based on the user discourse, the user discourse scenario, and the expression feature of the character; and
displaying and/or voice broadcasting the feedback discourse through the virtual human.

5. The method of claim 1, wherein
the deduction data includes an object image, and the obtaining input data includes obtaining the object image captured by a shooting device; and
the feature data of the character includes a portrait of the character, and the obtaining the feature data of the character based on the input data includes identifying the portrait included in the object image.

6. The method of claim 5, wherein the feature data of the character further includes a portrait feature of the character, and the generating a virtual human based on the feature data of the character and dynamically displaying the virtual human on a display interface includes:
generating portrait information based on the portrait feature, wherein the portrait information includes at least one of: a portrait type, a portrait facial feature, a portrait color feature, a portrait clothing feature, or a portrait size; and
generating an image of the virtual human based on the portrait and/or the portrait information.

7. The method of claim 1, wherein the feature data of the character further includes a facial expression feature and an action feature of the character, and the generating a virtual human based on the feature data of the character and dynamically displaying the virtual human on a display interface includes:
determining a target facial expression generator; generating, based on the expression feature and the facial expression feature, facial expression of the virtual human using the target facial expression generator, and displaying the facial expression by the virtual human; and/or
determining a target action trajectory simulator; generating, based on the expression feature and the facial expression feature, an action trajectory of the virtual human using the target action trajectory simulator, and executing the action trajectory by the virtual human.

8. The method of claim 1, wherein the dynamically displaying the virtual human on a display interface includes:
appearing the virtual human via a dynamic generation manner at a target position on the display interface, wherein,
the dynamic generation manner includes one or a combination of more of the following: the virtual human appears through a dynamic change in size, or the virtual human appears through a dynamic change in position.

9. The method of claim 1, wherein the dynamically displaying the virtual human on a display interface includes:
constructing an environmental map based on an environmental image captured by a shooting device;
determining a terminal position of a terminal device in the environmental map and a first position in the environmental map corresponding to a screen placement position of the virtual human in the display interface; and
adjusting the first position based on a position change of the terminal position, so that the screen placement position of the virtual human in the display interface is adjusted based on the adjusted first position, wherein a first distance between the first position and the terminal position is maintained.

10. A virtual human-based interaction system, comprising
at least one storage device storing executable instructions; and
at least one processor in communication with the at least one storage device, wherein when executing the executable instructions, the at least one processor is configured to cause the system to perform operations including:
obtaining input data, the input data including at least one of description data or deduction data of a character;
obtaining feature data of the character based on the input data, the feature data of the character at least includes an expression feature of the character;
generating a virtual human based on the feature data of the character; and
dynamically displaying the virtual human on a display interface.

11. The system of claim 10, wherein the obtaining input data includes:
determining a target data source and a target mining strategy based on the description data of the character, wherein the target mining strategy at least includes an associated feature; and
obtaining the deduction data of the character from the target data source based on the target mining strategy.

12. The system of claim 11, wherein the obtaining the feature data of the character based on the input data includes:
obtaining a deduction feature by filtering the deduction data; and
obtaining the feature data of the character based on the deduction feature.

13. The system of claim 10, wherein the generating a virtual human based on the feature data of the character and dynamically displaying the virtual human on a display interface includes:
obtaining a user discourse;
determining a user discourse scenario based on the input data;
generating a feedback discourse to a user based on the user discourse, the user discourse scenario, and the expression feature of the character; and
displaying and/or voice broadcasting the feedback discourse through the virtual human.

14. The system of claim 10, wherein
the deduction data includes an object image, and the obtaining input data includes obtaining the object image captured by a shooting device; and
the feature data of the character includes a portrait of the character, and the obtaining the feature data of the character based on the input data includes identifying the portrait included in the object image.

15. The system of claim 14, wherein the feature data of the character further includes a portrait feature of the character, and the generating a virtual human based on the feature data of the character and dynamically displaying the virtual human on a display interface includes:
generating portrait information based on the portrait feature, wherein the portrait information includes at least one of: a portrait type, a portrait facial feature, a portrait color feature, a portrait clothing feature, or a portrait size; and
generating an image of the virtual human based on the portrait and/or the portrait information.

16. The system of claim 10, wherein the feature data of the character further includes a facial expression feature and an action feature of the character, and the generating a virtual human based on the feature data of the character and dynamically displaying the virtual human on a display interface includes:
determining a target facial expression generator; generating, based on the expression feature and the facial expression feature, facial expression of the virtual human using the target facial expression generator, and displaying the facial expression by the virtual human; and/or
determining a target action trajectory simulator; generating, based on the expression feature and the facial expression feature, an action trajectory of the virtual human using the target action trajectory simulator, and executing the action trajectory by the virtual human.

17. The system of claim 10, wherein the dynamically displaying the virtual human on a display interface includes:
appearing the virtual human via a dynamic generation manner at a target position on the display interface, wherein,
the dynamic generation manner includes one or a combination of more of the following: the virtual human appears through a dynamic change in size, or the virtual human appears through a dynamic change in position.

18. The system of claim 10, wherein the dynamically displaying the virtual human on a display interface includes:
constructing an environmental map based on an environmental image captured by a shooting device;
determining a terminal position of a terminal device in the environmental map and a first position in the environmental map corresponding to a screen placement position of the virtual human in the display interface; and
adjusting the first position based on a position change of the terminal position, so that the screen placement position of the virtual human in the display interface is adjusted based on the adjusted first position, wherein a first distance between the first position and the terminal position is maintained.

19. A non-transitory computer readable medium, comprising at least one set of instructions for virtual human-based interaction, wherein when executed by at least one processor of a computing device, the at least one set of instructions direct the at least one processor to perform operations including:
obtaining input data, the input data including at least one of description data or deduction data of a character;
obtaining feature data of the character based on the input data, the feature data of the character at least includes an expression feature of the character;
generating a virtual human based on the feature data of the character; and
dynamically displaying the virtual human on a display interface.

20. The non-transitory computer readable medium of claim 19, wherein the obtaining the feature data of the character based on the input data includes:
obtaining a deduction feature by filtering the deduction data; and
obtaining the feature data of the character based on the deduction feature.
